(19) United States
(12) Patent Application Publication
(10) Pub. No.: US 2020/0044537 A1
(43) Pub. Date: Feb. 6, 2020

(54) VIBRATION MOTOR

(71) Applicant: AAC Technologies Pte. Ltd., Singapore city (SG)

(72) Inventors: Jinquan Huang, Shenzhen (CN); Mengxun Shi, Shenzhen (CN); Fanghua Ling, Shenzhen (CN); Tao Zhang, Shenzhen (CN)

(21) Appl. No.: 16/527,053

(22) Filed: Jul. 31, 2019

(30) Foreign Application Priority Data
Aug. 3, 2018 (CN) 201821245832.X

(51) Int. Cl. H02K 33/12

(52) U.S. Cl. CPC H02K 33/12; B06B 1/045

(57) ABSTRACT

Provided a vibration motor, including: a housing; a stator and a vibrator received in the housing; and an elastic support assembly received in the housing and elastically supporting the vibrator. The housing includes a top wall, a bottom wall opposite to the top wall, and a side wall connecting the top wall with the bottom wall. The stator includes a first coil provided on the top wall, a second coil provided on the bottom wall, an iron core corresponding to the coil, and an annular separator provided between the first coil and the second coil. The separator is sleeved on the iron core; the first and second coils are sleeved on the iron core from two ends of the iron core. The separator is sandwiched and fixed between the first and second coils. The elastic support assembly supports vibration of the vibrator along an axial direction.

### TECHNICAL FIELD

The present disclosure relates to the field of vibration motor technologies, and in particular, to a micro vibration motor applied to a mobile communication device.

### BACKGROUND

With the development of electronic technology, portable consumer electronic products such as mobile phones, handheld game consoles, navigation devices or handheld multimedia entertainment devices, etc., become more and more popular, which generally use vibration motors to do unit feedback, such as call reminder, message reminder, navigation reminder of mobile phones, vibration feedback of the game console, etc. Such a wide range of applications requires high performance and long service life of the vibration motor.

The vibration motor generally includes a housing having a receiving space, a vibrator received in the receiving space, and an elastic supporting assembly respectively connecting the housing and the vibrator. The elastic supporting assembly supports the vibrator to have a reciprocating motion in the horizontal direction in the housing so as to generate vibration. However, the vibration motor with such a structure is insufficiently compact, and the driving force provided is insufficient, so that it is difficult to meet the requirements of the vibration motor.

Therefore, it is necessary to provide a new vibration motor to solve the above problems.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic exploded view of a vibration motor according to an embodiment of the present disclosure; and

FIG. 2 is a cross-sectional view of a vibration motor according to an embodiment of the present disclosure.

### DESCRIPTION OF EMBODIMENTS

The present disclosure will be further illustrated with reference to the accompanying drawings and the embodiments.

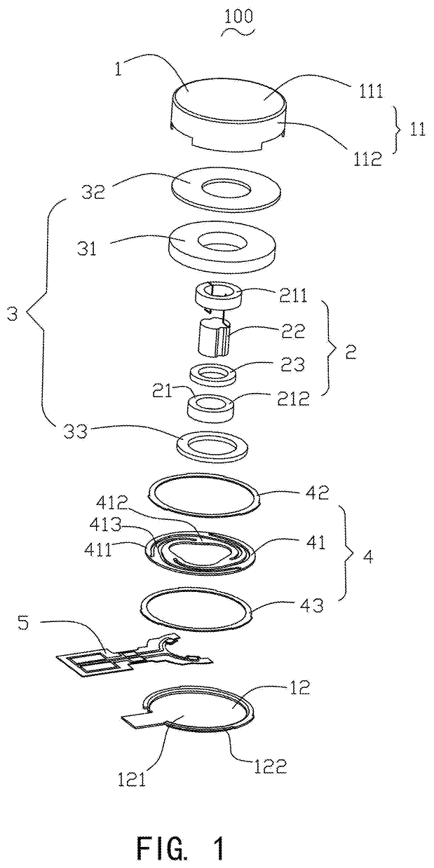

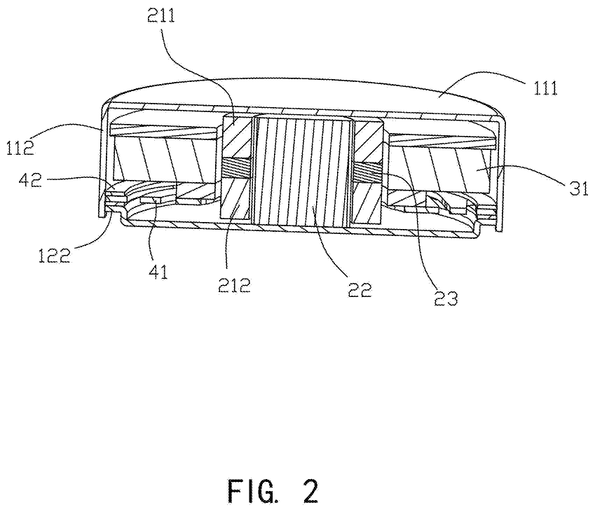

As shown in FIGS. 1 and 2, the present disclosure provides a vibration motor 100. The vibration motor 100 includes a housing 1, a stator 2, a vibrator 3, and an elastic support assembly 4 elastically supporting the vibrator 3. The stator 2, the vibrator 3 and the elastic support assembly 4 are received in the housing 1.

The housing 1 includes an upper housing 11 and a lower housing 12. The lower housing 12 cooperates with the upper housing 11 to form a receiving space. The upper housing 11 includes a top wall 111 and a side wall 112. The side wall 112 bends and extends from the top wall 111. The lower housing 12 includes a bottom wall 121 corresponding to the top wall 111, and a flange 122 bending and extending in a direction from an edge of the bottom wall 121 to the top wall 111. The flange 122 abuts against inner surface of the side wall 112, thereby realizing encapsulation of the housing 1.

The stator 2 is fixed on the housing 1. One end of the elastic support assembly 4 is connected to the vibrator 3, and the other end of the elastic support assembly 4 is connected to the side wall 112 of the housing 1.

The stator 2 includes a coil 21 provided on the housing 1, and a core 22 corresponding to the coil 21. The vibrator 3 includes an annular magnet 31. The magnet 31 surrounds the coil 21 and the core 22, and is spaced apart from the coil 21 and the core 22. The coil 21 is subject to the Lorentz force in a magnetic field during an energizing process, so that the vibrator 3 is driven to axially vibrate. In this embodiment, the coil 21 includes a first coil 211 provided on the top wall 111 and a second coil 212 provided on the bottom wall 121. The first coil 211 and the second coil 212 are flat coils that are sleeved on the iron core 22 from both ends of the iron core 22. During the energizing process, a magnetic field is formed between the coil 21 and the core 22, and a driving force in the axial direction is formed with the magnet 31 of the vibrator 3 to drive vibration of the vibrator 3.

Furthermore, a separator 23 is provided between the first coil 211 and the second coil 212. The lower surface of the separator 23 abuts against the upper surface of the second coil 212. The upper surface of the separator 23 abuts against the lower surface of the first coil 211. The outer diameters of the first coil 211, the second coil 212, and the separator 23 are all the same. The separator 23 has an annular structure and functions to separate the two voice coils for assisting positioning. The separator 23 may be made of a magnetic conductive material or a non-magnetic conductive material. Optionally, the separator 23 is made of a magnetic conductive material, so that it not only can play the role of assisting positioning, but also can act as an active magnetic guide to prevent the magnetic field in a same direction from passing through the two voice coils at the same time.

The vibrator 3 includes an annular magnet 31, a first pole plate 32 and a second pole plate 33. The annular magnet 31 surrounds the stator. The first pole plate 32 is provided at a side of the magnet 31 close to the top wall 111. The second pole plate 33 is provided at a side of the magnet 31 close to the bottom wall 121. The first pole plate 32 is bonded to the upper surface of the magnet 31, and its structure is completely the same as that of the magnet 31. The second pole plate 33 is bonded to the lower surface of the magnet 31. The second pole plate 33 has a same inner diameter as the magnet 31 and has a smaller outer diameter than the magnet 31, thereby facilitating combination of the vibrator 3 and the elastic support assembly 4.

The elastic support assembly 4 includes an annular spring piece 41, a first fixed ring 42 and a second fixed ring 43. The first fixed ring 42 and the second fixed ring 43 are provided at both sides of the spring piece 41. The spring piece 41 includes an outer ring 411 connected to the housing 1, an inner ring 412 connected to the vibrator 3, and a connection ring 413 connecting the outer ring 411 and the inner ring 412. The outer ring 411 of the spring piece 41 is sandwiched and fixed between the first fixed ring 42 and the second fixed ring 43. The second fixed ring 43 is provided at the lower surface of the spring piece 41 and overlaps the flange 122 of the housing 1, thereby achieving fixation of the elastic support assembly 4 and the vibrator 3.

Further, the vibration motor further includes a flexible circuit board 5 for realizing electrical connection to the coils 21.

The vibration motor of the present disclosure includes a housing, a stator received in the housing, a vibrator, and an elastic support assembly elastically supporting the vibrator. The housing includes a top wall, a bottom wall opposite to the top wall, and a side wall connecting the top wall and the bottom wall. The stator includes a first coil provided on the top wall, a second coil provided on the bottom wall, an iron core corresponding to the coil, and an annular separator sandwiched between the first coil and the second coil. The separator is sleeved on the iron core. The first coil and the second coil are sleeved on the iron core from two ends of the iron core. The separator is sandwiched and fixed between the first coil and the second coil. The vibrator is a ring structure sleeved on a circumferential side of the stator and spaced apart from the stator. The elastic support assembly supports the vibrator to vibrate in the axial direction. The vibration motor of the structure is compact in structure, and the driving efficiency is large without changing the size of the vibration motor, thereby achieving a better vibration effect.

The above are only preferred embodiments of the present disclosure. Here, it should be noted that those skilled in the art can make modifications without departing from the inventive concept of the present disclosure, but these shall fall into the protection scope of the present disclosure.

What is claimed is:

1. A vibration motor, comprising:
a housing;
a stator received in the housing;
a vibrator received in the housing; and
an elastic support assembly received in the housing and elastically supporting the vibrator,
wherein the housing comprises a top wall, a bottom wall opposite to the top wall, and a side wall connecting the top wall with the bottom wall; the stator comprises a first coil provided on the top wall, a second coil provided on the bottom wall, an iron core corresponding to the coil, and an annular separator provided between the first coil and the second coil; the separator is sleeved on the iron core; the first coil and the second coil are sleeved on the iron core from two ends of the iron core; the separator is sandwiched and fixed between the first coil and the second coil; the vibrator is a ring structure sleeved on a circumferential side of the stator and spaced apart from the stator; and the elastic support assembly supports vibration of the vibrator along an axial direction.

2. The vibration motor as described in claim 1, wherein the separator is made of a magnetic conductive material.

3. The vibration motor as described in claim 1, wherein the vibrator comprises an annular magnet, a first pole plate provided at a side of the magnet close to the top wall, and a second pole plate provided at a side of the magnet close to the bottom wall.

4. The vibration motor as described in claim 3, wherein the elastic support assembly comprises an annular spring piece, the spring piece comprising an outer ring connected to the housing, an inner ring connected to the vibrator, and a connection ring connecting the outer ring with the inner ring.

5. The vibration motor as described in claim 4, wherein one side of the second pole plate abuts against a bottom of the magnet, and the other side of the second pole plate is connected to the outer ring of the spring piece.

6. The vibration motor as described in claim 5, wherein the elastic support assembly further comprises a first fixed ring and a second fixed ring, the spring piece being sandwiched and fixed between the fixed ring and the second fixed ring; and the outer ring of the spring piece is sandwiched between the first fixed ring and the second fixed ring and connected to the housing through the first fixed ring and the second fixed ring.

7. The vibration motor as described in claim 6, wherein the housing comprises an upper housing having the top wall and the side wall, and a lower housing assembled with the upper housing to form a receiving space; the lower housing comprises the bottom wall and a flange extending from the bottom wall while being bent towards the top wall, the flange is in contact with an inner surface of the side wall, and the elastic support assembly overlaps the flange.

8. The vibration motor of claim 1, further comprising a flexible circuit board provided on the bottom wall and electrically connected to the coil.
